(19) United States
(12) Patent Application Publication
(10) Pub. No.: US 2007/0247301 A1
(43) Pub. Date: Oct. 25, 2007

(54) Voice protector security alarm system

(76) Inventor: Michael A. Browne, Holtsville, NY (US)

Correspondence Address: Michael A. Browne, 47 Cassa Loop, Holtsville, NY, 11742, US

(21) Appl. No.: 11/373,597

(22) Filed: Apr. 20, 2006

(51) Int. Cl. G08B 29/00; G08B 13/00; G05B 19/00

(52) U.S. Cl. 340/506; 340/574; 340/5.84

(57) ABSTRACT

The Voice Protector Security Alarm is an improvement to current alarm systems that are on the market today. The voice sensors are placed in normal home objects that home invaders will not notice. In the instance of a home invasion, the victim calls for help, the voice is picked up through a sensor and a strobe light is activated to ensure the victim that help is on the way. This signal goes to a central station or law enforcement agency. They in turn, send help. Upgrades to this system are digital photos that are transmitted of the area in question to the central station, allowing authorities to identify the perpetrators.

The main difference with this invention is that this security alarm is voice activated to a central station, with a small strobe light that is activated upon receipt of the command and lets the victim know authorities have been notified. This system will have the capabilities of expanding to still digital photos that go back to the central station.

### BACKGROUND OF THE INVENTION

1. Field of the Invention

This invention relates generally to the field of apparatus for an alarm system for use in a home or in a business. Moreover it pertains specifically to such apparatus for a voice activated alarm system with a strobe that acknowledges receipt of command. This improvement to the current security systems also includes upgrades for digital pictures sent to corresponding central stations &/or law enforcement agencies.

### SUMMARY OF THE INVENTION

In view of the limitations now present in the prior art, the present invention provides a new and useful voice activated alarm system, which is simpler in construction, more universally usable and more versatile in operation than known apparatus of this kind.

The purpose of the present invention is to provide a new security device that has many novel features not offered by the prior apparatus that result in a new more secure device which is not apparent, obvious, or suggested, either directly or indirectly by any of the prior apparatus.

This system can be mounted in overhead lights, in HVAC registers or any normal household location. It consists of a receiver to “hear” the verbal command such as “send police”, a strobe to acknowledge that the command has been received and the proper message sent, and an optional digital camera to send photos of the area to the proper authorities. The receiver will be set to a certain decibal so that the verbal command will not be confused with normal conversation.

The foregoing has outlined, in general, the physical aspects of the invention and is to serve as an aid to better understanding the more complete detailed description which is to follow. In reference to such, there is to be a clear understanding that the present invention is not limited to the method or detail of construction, fabrication, material, or application of use described and illustrated herein. Any other variation of fabrication, use, or application should be considered apparent as an alternative embodiment of the present invention.

### OBJECTS OF THE INVENTION

Accordingly several advantages and objects of the present invention are:

A principal object of the present invention is to provide a first line of defense in the event of a home invasion that will overcome the deficiencies of the prior devices.

An object of the present invention is to provide a security alarm device that will respond to voice commands.

Another object of the present invention is to provide a small strobe device that will let the victim know that the alarm has been activated.

Another object of the present invention is to provide a microscopic camera (wide angle) device that will take photos of the area and transmit them to the proper Central Station or law enforcement authorities.

Another object of the present invention is to provide a feeling of security that makes violent home invasions a thing of the past.

It is intended that any other advantages and objects of the present invention that become apparent or obvious from the detailed description or illustrations contained herein are within the scope of the present invention.

### BRIEF DESCRIPTION OF THE DRAWINGS

The following drawings further describe by illustration the advantages and objects of the present invention. Each drawing is referenced by corresponding figure reference characters within the “DETAILED DESCRIPTION OF THE INVENTION” section to follow.

FIG. 1. is a perspective view of how, by placing voice sensors with “command received strobes and sensors” in all rooms of the home and business the new system can be acclimated to the existing security system, or it can be part of one brand new unit according to the present invention.

FIG. 2. shows some possible locations one can have the sensors mounted to fit in with items that are normally found in the home (or business).

FIG. 3 shows a view of home with a home invasion in progress. This figure shows exactly how the invention will keep the family safe by notifying the proper authorities in a timely manner.

### DETAILED DESCRIPTION OF THE INVENTION

Referring now descriptively to the drawings, the following examples illustrate components of the security system, with voice commands to alert the proper authorities.

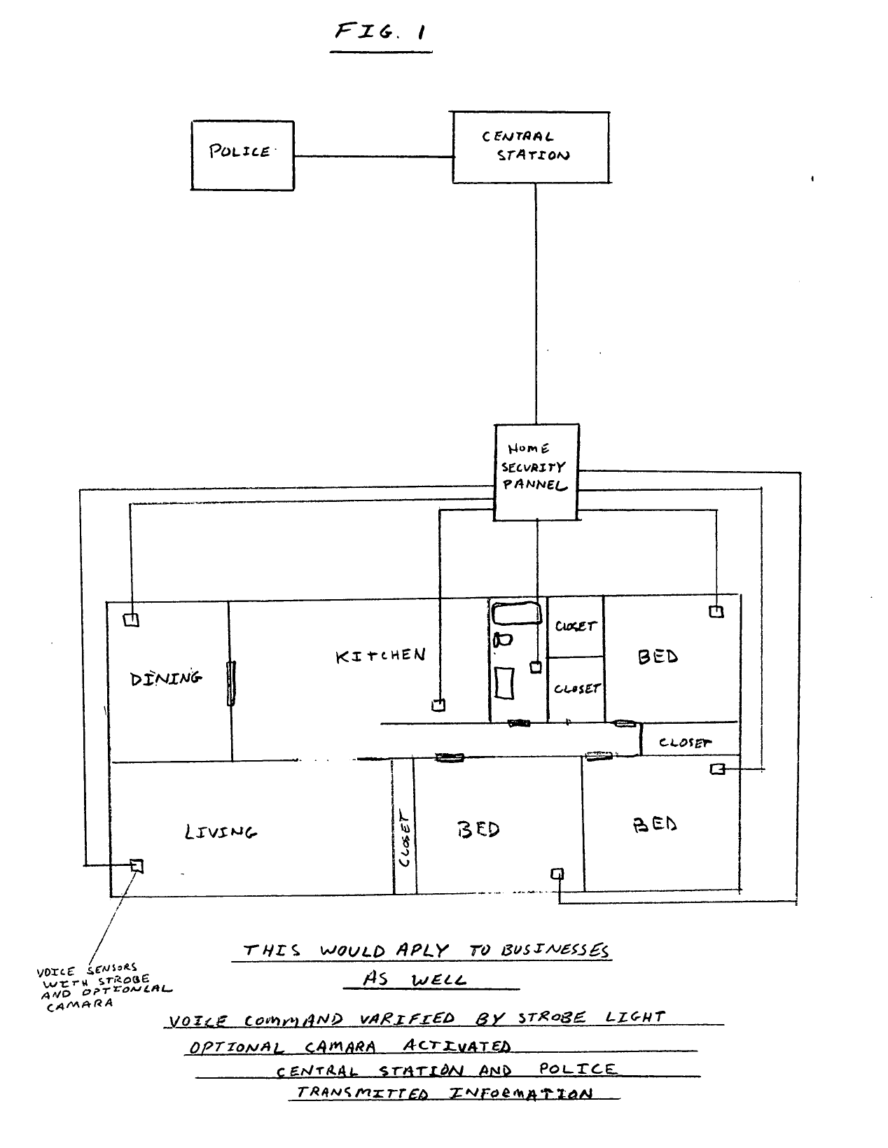

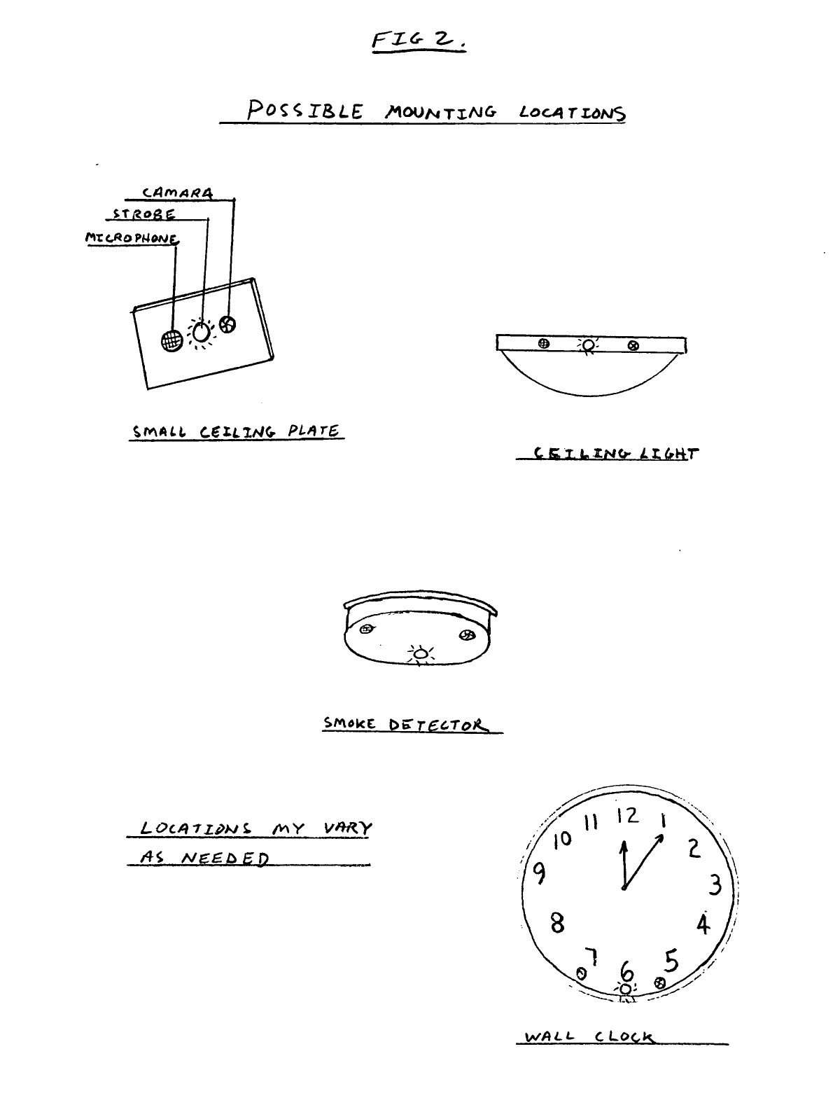

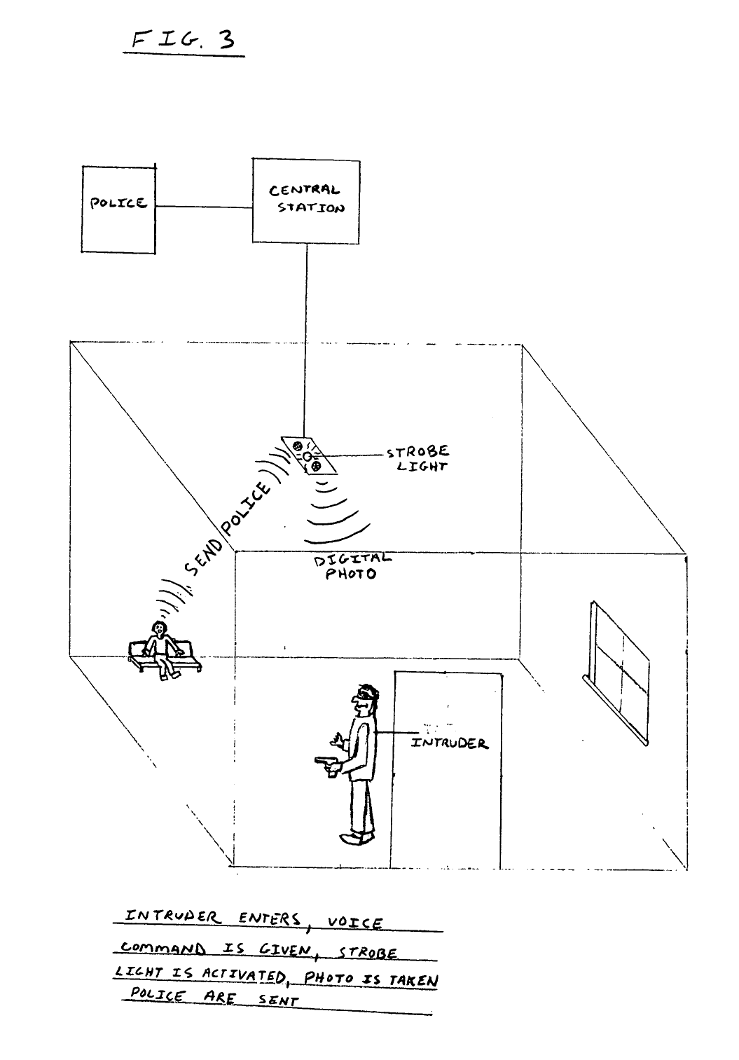

FIGS. 1-3 illustrate a layout of a home with the Voice Protector Security System in place, and according to the present invention, how voice activated commands gets the law enforcement authorities to help you, and let you be aware that the system has been activated.

The fact that this invention is an improvement to an existing product, and the technology for the separate components already exists. This invention joins voice command technology with a strobe light for a visual acknowledgement that the command has been received. This then triggers an optional digital camera to let the proper authorities know the extent of the home invasion. It would allow the command center to know the number of assailants, and what they look like. Law enforcement officials would have the physical proof of the invasion. This system is unique in the fact that commands can be given by anyone in the household from any room. With other panic button systems unless the alarm is on your person, or you are in close proximity to the alarm, you will be rendered helpless before you can get to it. With this improved system, you could even be in a struggle with a perpetrator who grabbed you from behind, and as long as you can get out the specific command, you can be assured that help is on the way.

It will also be understood that, in addition to a home security alarm system, the device can be used for businesses as well.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

What I claim is:

1) a voice activated security system, wherein the alarm is activated by the homeowner/business owner's pre-determined voice commands, such as “send police”.
A method of this claim is to have the sensor for the alarm in a ceiling plate or any other inconspicuous place, such as an air conditioning vent or smoke detector, that also has a small light (i.e. strobe) that will blink to let the person in trouble know that the system has received the command and is alerting the central station or proper authorities.
Another method of this claim is to have the command set at an adjustable decibel setting so as not to be confused with normal conversation.

2) This security system is expandable.
A method to claim 2 is that options that can be added would include cameras at each sensor to take wide-angle digital pictures of the location where command was received and/or every room in the home and send them to the authorities to let them know where in the home the invasion is taking place, how many assailants there are, etc.
A second method to this claim would be to have a default time between these photos set at ten (10) second intervals. The home/business owner can adjust the rate of pictures at their discretion.
